(19) United States
(12) Patent Application Publication
(10) Pub. No.: US 2024/0279487 A1
(43) Pub. Date: Aug. 22, 2024

(54) COMPOSITION OF WATER REPELLENT AND WATERPROOF

(71) Applicant: Young Ho HEO, Gimhae-si (KR)

(72) Inventor: Young Ho HEO, Gimhae-si (KR)

(21) Appl. No.: 18/639,775

(22) Filed: Apr. 18, 2024

Related U.S. Application Data
(63) Continuation-in-part of application No. 17/483,581, filed on Sep. 23, 2021.

(30) Foreign Application Priority Data
Sep. 24, 2020 (KR) 10-2020-0123500

(51) Int. Cl. C09D 5/16; C09D 7/61; C09D 183/08

(52) U.S. Cl. CPC C09D 5/1675; C09D 7/61; C09D 183/08

(57) ABSTRACT

Disclosed is a novel waterproof/water-repellent composition in which the shrinkage, expansion, deterioration, aging, etc. of the conventional waterproof/water-repellent composition are alleviated. More specifically, disclosed is a reinforced waterproof/water-repellent composition capable of preventing a crevice leakage due to the shrinkage of the conventional silicone without causing a shrinkage after construction, which thus provides a transparent aqueous acrylic silicone-based waterproof/water-repellent composition.

### TECHNICAL FIELD

The present invention relates to a novel waterproof/water-repellent composition in which the shrinkage, expansion, deterioration, aging, etc. of the conventional waterproof/water-repellent composition are alleviated and, more specifically, to a reinforced waterproof/water-repellent composition capable of preventing a crevice leakage due to the shrinkage of the conventional silicone without causing a shrinkage after construction, which thus provides a transparent aqueous acrylic silicone-based waterproof/water-repellent composition comprising:
100 parts by weight of composition A, wherein the composition A includes 1 to 3 wt % of a silyl compound of formula (1) below,
1 to 3 wt % of organosilane of formula (2) below,
1 to 2 wt % of aminosiloxane of formula (3) below,
4 to 12 wt % of one or two or more acrylic resins selected from butylacrylate, ethylacrylate, methylacrylate, 2-ethylhexyl acrylate, methacrylates, 2-chloroethyl vinyl ether (2-chloroethyl vinyl ether), hydroxyethyl methacrylate, butyl methacrylate, and trimethylolpropane triacrylate (TMPTA),
0.03 to 0.05 wt % of a pH stabilizer,
0.003 to 0.005 wt % of a chelating agent, and
80 to 92 wt % water,

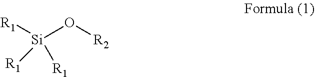

wherein R1 is a linear or branched saturated alkyl group having 1 to 5 carbon atoms, and R2 is a linear or branched saturated alkyl group having 1 to 18 carbon atoms,

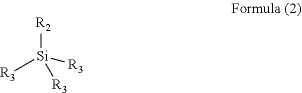

wherein R2 is an alkyl group having 1 to 12 carbon atoms, and R3 is an alkoxy group having 1 to 6 carbon atoms,

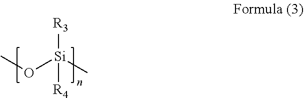

wherein R3 is a saturated alkyl group having 1 to 5 carbon atoms, R4 is an alkyl group having 1 to 18 carbon atoms containing at least one nitrogen (N), and n is 3 or more;
   0.5 to 5 parts by weight of composition B including 27 to 29 parts by weight of 2-ethylhexyl acrylate, polymer of 1-methyl-4-vinylbenzene and isobutyl methacrylate, and 71 to 73 parts by weight of water; and 70 to 87 parts by weight of silica powder.

### BACKGROUND ART

In general, silicone installed on a door frame, etc., has a problem of being shrunk over time, resulting in a gap and leakage. In addition, a transparent aqueous acrylic waterproof/water-repellent composition applied to concrete or building surfaces has properties of shrinkage, expansion, deterioration, aging, etc., due to UV, humidity, mold, etc., after construction, thereby mainly causing a leakage.

In order to solve the problem, Patent Registration No. 10-2043857, which has been jointly filed by the present applicant and registered, discloses an elastic inorganic composition such as silica sand, etc., an inorganic coating composition made of a silyl compound, etc., and an inorganic elastic coating composition made of a water-soluble acrylic resin, cement, glass bead or the like, and a construction method thereof, but has a problem of becoming stiff to lose elasticity when hardening due to components such as concrete after construction.

To solve the above problems of the prior art, there is provided a novel waterproof/water-repellent composition obtained by mixing 0.5 to 5 parts by weight of composition B formed of acrylates copolymer (CAS No. 25133-97-5), 2-ethylhexyl acrylate, polymer of 1-methyl-4-vinylbenzene and isobutyl methacrylate, which is a thickener, and water, and 70-87 parts by weight of silica powder in 100 parts by weight of transparent aqueous acrylic waterproof/water-repellent composition A, followed by stirring, in which the waterproof/water-repellent composition with excellent elasticity, non-shrinkage and slip resistance continuously maintains non-shrinkage and elasticity after construction, provides elasticity as well as an anti-slip effect, etc., due to rough properties caused by a silica powder component during the construction of a floor surface, and may be used as an excellent substitute for silicone in a door flame, etc.

The present invention may provide a waterproof/water-repellent composition which does not contain a solidifying component such as cement, etc., but contains a mixture of 0.5 to 5 parts by weight of composition B made of 27 to 29 parts by weight of the acrylates polymer and 71 to 73 parts by weight of water, so as to transform composition A from a watery state to a cream state, thereby providing excellent elasticity, non-shrinkability, and anti-slip properties along with silica powder after construction.

As such, the present invention may provide an excellent waterproof/water-repellent composition which can be an excellent substitute for silicone, can be installed on an exposed outer surface of buildings, and can be also installed on the floor to form an anti-slip floor, and thus is widely available as an item for small business.

### DISCLOSURE

### Technical Problem

An object of the present invention is to provide a waterproof/water-repellent composition which does not contain a solidifying component such as cement, etc., after construction, but is formed with waterproof/water-repellent composition A of formulas (1)-(3), composition B made of 27 to 29 parts by weight of 2-ethylhexyl acrylate, polymer of 1-methyl-4-vinylbenzene and isobutyl methacrylate and 71 to 73 parts by weight of water, and 70 to 87 parts by weight of silica powder, so as to solve a problem of shrinkage of silicon, form an anti-slip floor when being installed on an exposed outer surface of buildings, and maintain continuous elasticity.

### Technical Solution

To achieve the above objects, the present invention may provide a reinforced waterproof/water-repellent composition capable of preventing a crevice leakage due to the shrinkage of the conventional silicone without causing a shrinkage after construction, which thus provides a transparent aqueous acrylic silicone-based waterproof/water-repellent composition comprising:
100 parts by weight of composition A, wherein
the composition A includes 1 to 3 wt % of a silyl compound of formula (1) below,
1 to 3 wt % of organosilane of formula (2) below,
1 to 2 wt % of aminosiloxane of formula (3) below,
4 to 12 wt % of one or two or more acrylic resins selected from butylacrylate, ethylacrylate, methylacrylate, 2-ethylhexyl acrylate, methacrylates, 2-chloroethyl vinyl ether (2-chloroethyl vinyl ether), hydroxyethyl methacrylate, butyl methacrylate, and trimethylolpropane triacrylate (TMPTA),
0.03 to 0.05 wt % of a pH stabilizer,
0.003 to 0.005 wt % of a chelating agent, and
80 to 92 wt % water,

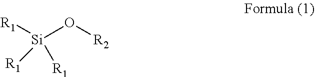

wherein R1 is a linear or branched saturated alkyl group having 1 to 5 carbon atoms, and R2 is a linear or branched saturated alkyl group having 1 to 18 carbon atoms,

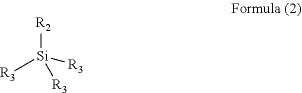

wherein R2 is an alkyl group having 1 to 12 carbon atoms, and R3 is an alkoxy group having 1 to 6 carbon atoms,

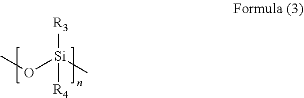

wherein R3 is a saturated alkyl group having 1 to 5 carbon atoms, R4 is an alkyl group having 1 to 18 carbon atoms containing at least one nitrogen (N), and n is 3 or more;
0.5 to 5 parts by weight of composition B including 27 to 29 parts by weight of 2-ethylhexyl acrylate, polymer of 1-methyl-4-vinylbenzene and isobutyl methacrylate, and 71-73 parts by weight of water; and
70 to 87 parts by weight of silica powder.

Composition A may be a transparent aqueous acrylic silicone-based waterproof/water-repellent composition applied to a surface of building walls disclosed in Patent Registration No. 10-1811559, which includes 1-3 wt % of a silyl compound of formula (1), 1-3 wt % of an organosilane of formula (2) and 1-2 wt % of an amino siloxane of formula (3) as a main ingredient with the addition of a predetermined amount of a pH stabilizer, a chelating agent and water.

Composition A may be applied to a surface of building walls to form an excellent waterproof and water-repellent protective film, may provide excellent durability, chemical resistance, waterproofness, water repellency, etc. to a wall structure, may prevent moisture, mold, moss, etc., may have excellent resistance to environmental and weather conditions inside and outside the building as well as excellent fouling resistance, so as to extend the life of the building, and other specific details are described in the specification of the publication No. 10-1811559, and thus are omitted.

In composition B, 2-ethylhexyl acrylate, polymer of 1-methyl-4-vinylbenzene and isobutyl methacrylate may have a molecular formula of C₂₈H₄₄O₄ with CAS No. 118922-88-6, and is used as a thickener and for various other purposes.

The composition B, which is formed of 2-ethylhexyl acrylate, polymer of 1-methyl-4-vinylbenzene and isobutyl methacrylate and a predetermined amount of water, may harden after construction by forming the composition from a watery state to a creamy state, so as to continuously maintain non-shrinkability and elasticity.

In addition, it may be confirmed from the present invention that the waterproof/water-repellent function of composition A is formed with the composition A and silica powder so as to form continuous elasticity, non-shrinkability and surface roughness, thereby providing a novel effect of an excellent anti-slip property, which has not been found from the conventional techniques. Accordingly, the composition of the present invention may be applied to concrete, a building surface, a floor, and a gap through a silicone gun for various purposes such as filling gaps.

The present invention may enhance a water-repellent function by further mixing one to three of silicic acid, diethoxyoctylsilyl trimethylsilyl ester (CAS No. 216689-57-5), n-octyltriethoxysilane (CAS No. 2943-75-1), siloxanes and silicones, di-Me, polymers with 3-(2-aminoethyl)aminopropyl silsesquioxanes, hydroxy-terminated (CAS No. 68554-54-1) by a predetermined amount.

### Advantageous Effects

The present invention can provide a novel waterproof/water-repellent composition obtained by mixing 0.5 to 5 parts by weight of composition B including acrylates copolymer, which is a thickener, and water, and 70 to 87 parts by weight of silica powder in 100 parts by weight of transparent aqueous acrylic waterproof/water-repellent composition A, followed by stirring, thereby continuously maintaining non-shrinkage and elasticity with a more remarkable waterproof/water-repellent effect when compared with that of the related art.

In addition, the present invention has an effect of providing an anti-slip floor by forming a rough surface that is hardened due to a silica powder component during the construction of a floor surface along with elasticity.

Furthermore, the present invention has an effect of providing a waterproof/water-repellent composition with continuously excellent elasticity and non-shrinkage even under ultraviolet rays, moisture, temperature, etc. when constructed as a substitute for silicone on a door frame, etc., by forming a composition having a creamy property.

### MODE FOR INVENTION

In order to take the composition of Patent Registration No. 10-2043857 and silicon in the related art as comparative examples and compare with Example 1 of the present invention, a waterproof/water-repellent composition was prepared as Example 1 of the present invention by mixing 100 parts by weight of transparent aqueous acrylic silicone-based waterproof/water-repellent composition A formed by mixing 2 wt % of a silyl compound of formula (1) of the present invention, 2 wt % of organosilane of formula (2), 1.94 wt % of aminosiloxane of formula (3), and 8 wt % of butylacrylate as an aqueous acrylic resin; 0.06 wt % of a pH stabilizer and a chelating agent; and 86% by weight water, 1 part by weight of composition B formed of 28 parts by weight of an acrylic polymer and 72 parts by weight of water, and 80 parts by weight of silica powder.

Comparative Example 1 was provided by mixing/stirring 40 parts by weight of a first composition of Patent Registration No. 10-2043857, which is a waterproof/water-repellent composition of the related art, 30 parts by weight of a second composition, 5 parts by weight of an inorganic elastic resin portion, 10 parts by weight of an inorganic elastic powder portion, 5 parts by weight of a water-soluble acrylic resin, and 10 parts by weight of cement, and a commercially available silicone (to be constructed by shooting with a silicone gun) was prepared as Comparative Example 2.

Example 1 and Comparative Examples 1 and 2 were coated and compared with each other in terms of elasticity and non-shrinkage properties through drying, heat and UV exposure.

TABLE 1

| | Continuous | |
|---|---|---|
| | elasticity | Non-shrinkage |
| Example 1 | Excellent | Excellent |
| Comparative | Poor | Excellent |
| Example 1 | | |
| Comparative | Poor | Poor |
| Example 2 | | |

As shown in table 1, it could be confirmed that Example 1 of the present invention has excellent elasticity and non-shrinkage even after undergoing poor drying, heat, and UV exposure. However, it could be confirmed that Comparative Example 1 has an excellent non-shrinkage property, but fails to maintain elasticity, while Comparative Example 2 (silicone) exhibits shrinkage and remarkably decreased elasticity.

In addition, as a result of comparing Examples in which a composition ratio of each component of the present invention slightly varies with Comparative Examples in which a composition ratio of Comparative Example 1 slightly varies, it could be understood that both show the same or similar results and may be applied to the floor for the purpose of waterproofing/repellency of concrete and buildings, thereby providing roughness and effective slip-resistant properties.

Furthermore, when Example of the present invention was put into a silicone gun and used for filling gaps, it was possible to maintain elasticity without shrinkage even after a considerable period of time elapsed.

Besides, it could be understood that the present invention may enhance a water-repellent function by mixing silicic acid, diethoxyoctylsilyl trimethylsilyl ester (CAS No. 216689-57-5), n-octyltriethoxysilane (CAS No. 2943-75-1), siloxanes and silicones, di-Me, polymers with 3-(2-aminoethyl)aminopropyl silsesquioxanes, hydroxy-terminated (CAS No. 68554-54-1).

Through the examples of the present invention, it could be confirmed that the present invention has the effect of the novel waterproof/water-repellent composition with significantly improved elastic, non-shrinkable, rough, and water repellent functions compared to the related art.

The configuration of the present invention is not limited to the above embodiments, and includes various embodiments that can be carried out in the conventional technical scope.

What is claimed is:

1. A waterproof/water-repellent composition comprising:
100 parts by weight of composition A, wherein
the composition A includes 1 to 3 wt % of a silyl compound of formula (1) below,
1 to 3 wt % of organosilane of formula (2) below,
1 to 2 wt % of aminosiloxane of formula (3) below,
4 to 12 wt % of one or two or more resins of one or more monomers selected from butylacrylate, ethylacrylate, methylacrylate, 2-ethylhexyl acrylate, methacrylates, 2-chloroethyl vinyl ether (2-chloroethyl vinyl ether), hydroxyethyl methacrylate, butyl methacrylate, and trimethylolpropane triacrylate (TMPTA),
0.03 to 0.05 wt % of a pH stabilizer,
0.003 to 0.005 wt % of a chelating agent, and
80 to 92 wt % water, 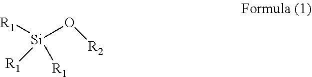
wherein R1 is a linear or branched saturated alkyl group having 1 to 5 carbon atoms, and R2 is a linear or branched saturated alkyl group having 1 to 18 carbon atoms, 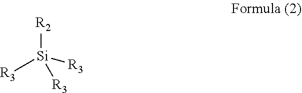
wherein R2 is an alkyl group having 1 to 12 carbon atoms, and R3 is an alkoxy group having 1 to 6 carbon atoms, 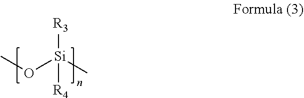
wherein R3 is a saturated alkyl group having 1 to 5 carbon atoms, R4 is an alkyl group having 1 to 18 carbon atoms containing at least one nitrogen (N), and n is 3 or more;
0.5 to 5 parts by weight of composition B including 27 to 29 parts by weight of 2-ethylhexyl acrylate, polymer of 1-methyl-4-vinylbenzene and isobutyl methacrylate, and 71 to 73 parts by weight of water; and
70 to 87 parts by weight of silica powder.
